(19) United States
(12) Patent Application Publication
(10) Pub. No.: US 2013/0221632 A1
(43) Pub. Date: Aug. 29, 2013

(54) VEHICLE STEP, STEP ASSEMBLY AND METHOD OF FORMING A STEP ASSEMBLY

(71) Applicants: Gregory Neal HIGGS, Fort Mill, SC (US); Eric Anthony RAFALKO, Raleigh, NC (US)

(72) Inventors: Gregory Neal HIGGS, Fort Mill, SC (US); Eric Anthony RAFALKO, Raleigh, NC (US)

(73) Assignee: FAB FOURS INC., Lancaster, SC (US)

(21) Appl. No.: 13/406,059

(22) Filed: Feb. 27, 2012

(51) Int. Cl. B60R 3/00; B23P 11/00

(52) U.S. Cl. 280/169; 29/428

(57) ABSTRACT

A vehicle step includes a tread, a riser at a rear of the step that extends from the tread, and a side wall that extends from the tread and the riser. A top part may extend from the side wall and slope outward to a front of the tread, and an outer part may extend from the top part and at an outward angle. The step may be stamped from a single sheet of material.

### BACKGROUND

The disclosure relates to a vehicle step, a step assembly and a method of forming the step assembly.

Some vehicles, such as trucks and sport utility vehicles, are high off the ground in order to provide a high road clearance for off-roading or to avoid debris. In addition, some vehicles can be “lifted” after manufacture in order to provide higher road clearance and/or to improve their appearance.

Some users may find it difficult climbing into and out of a vehicle, or reaching various parts of the vehicle from the ground. Steps may thus be added to the vehicle as an accessory. The steps may be part of or attached to running boards or side bars that are attached to the vehicle.

A U-shaped cylindrical tube with both ends of the tube attached to a side bar has been disclosed as a step. However, a user may slip on the tube because the area on which the user steps is small. In addition, the user's foot can easily pass through the open space between the tube and the side bar.

### SUMMARY

Aspects of the disclosure include a step that is stamped from a single piece of material and may be attached to a side bar. The manufacturing process is simplified because the entire step may be formed in one stamping process. The step is lower to the ground than the side bar so that a user can easily reach the step. The stamped step may include a riser extending from the tread in order to prevent a user's foot from slipping through and/or off of the step. The steps may include side walls, which can also help avoid having the user's foot slip through and/or off of the step. The tread may be wide to support a large area of the user's foot. These and other advantages can be achieved according to various aspects of the disclosure.

A step assembly can include a side bar and a stamped step attached to the side bar. For example, a step assembly can include a substantially horizontal side bar and a step attached to the side bar, the step comprising a tread, a riser and a pair of side walls. In embodiments, a top of the side walls may be shaped to mate with a shape of the side bar. In embodiments, the side walls and riser may each have a surface that mates with the side bar. In embodiments, the tread and the side walls have surfaces that extend laterally beyond a lateral surface of the side bar. In embodiments, the step assembly can be formed by attaching a stamped step to a tubular side bar, wherein a top of the side portions is formed to mate with a shape of the side bar.

### BRIEF DESCRIPTION OF THE DRAWINGS

Various exemplary aspects of the disclosure will be described with reference to the drawings, wherein:

FIG. 1 is a perspective view of a step assembly;

FIG. 2 is a top view of a step assembly;

FIG. 3 is a side view of a step assembly;

FIG. 4 is a perspective view of a step;

FIG. 5 is a top view of a step; and

FIG. 6 is a side view of a step.

### DETAILED DESCRIPTION OF EMBODIMENTS

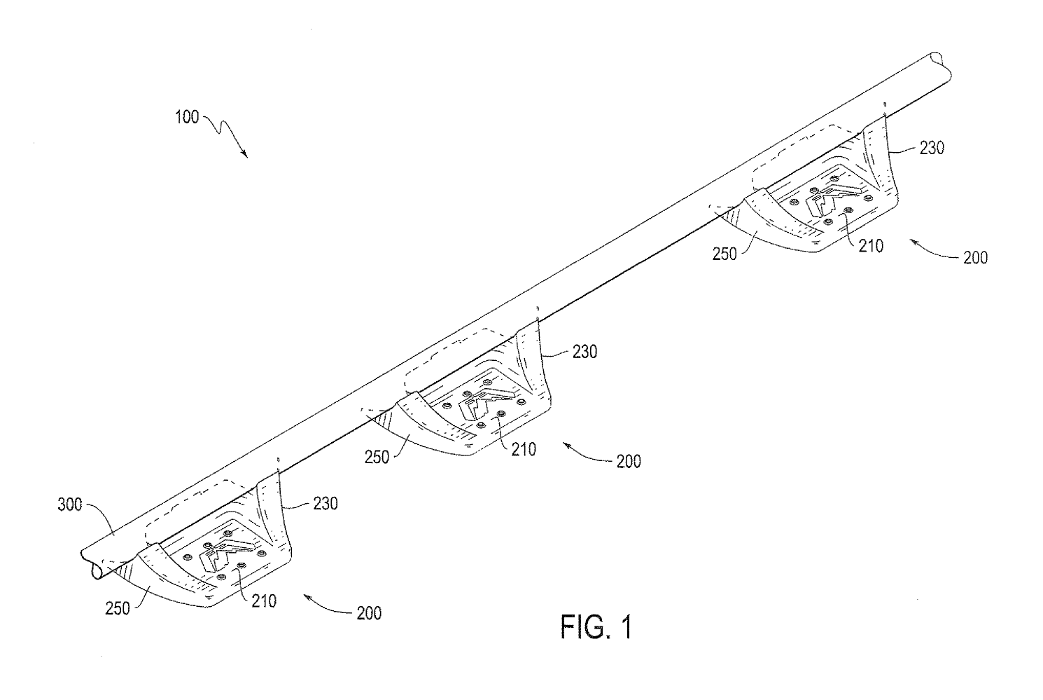

FIGS. 1-3 illustrate step assembly 100. The step assembly 100 includes a step 200 that is attached to a bar 300. The step 200 may be welded (e.g., at surfaces 235, 255 and/or 245), bolted, or otherwise attached to the bar 300, preferably such that the step 200 is rigidly attached to the bar 300. Although FIGS. 1-3 illustrate three steps 200 attached to the bar 300, one, two or any number of steps 200 may be attached to the bar 300.

The bar 300, depicted in FIGS. 1-3, is a longitudinal tubular side bar that may be attached to the frame of a vehicle (such as a truck or a sport utility vehicle) such that the bar 300 is at an appropriate height and horizontally positioned so that a user can easily step on the step 200. The bar 300, however, may be tubular or solid, and may have any cross-sectional shape including, but not limited to, a square, a rectangle, a trapezoid, a triangle, an oval, an ellipse, or any other suitable shape. The bar 300 may be welded, bolted or otherwise attached to the vehicle, preferably such that the bar 300 is rigidly attached to the vehicle, for example to the vehicle frame, chassis or body. In addition, the bar 300 can be of any length, and can extend the length of the entire vehicle, the length of the vehicle between wheel wells, the length of only one door, or the width (front or rear), for example.

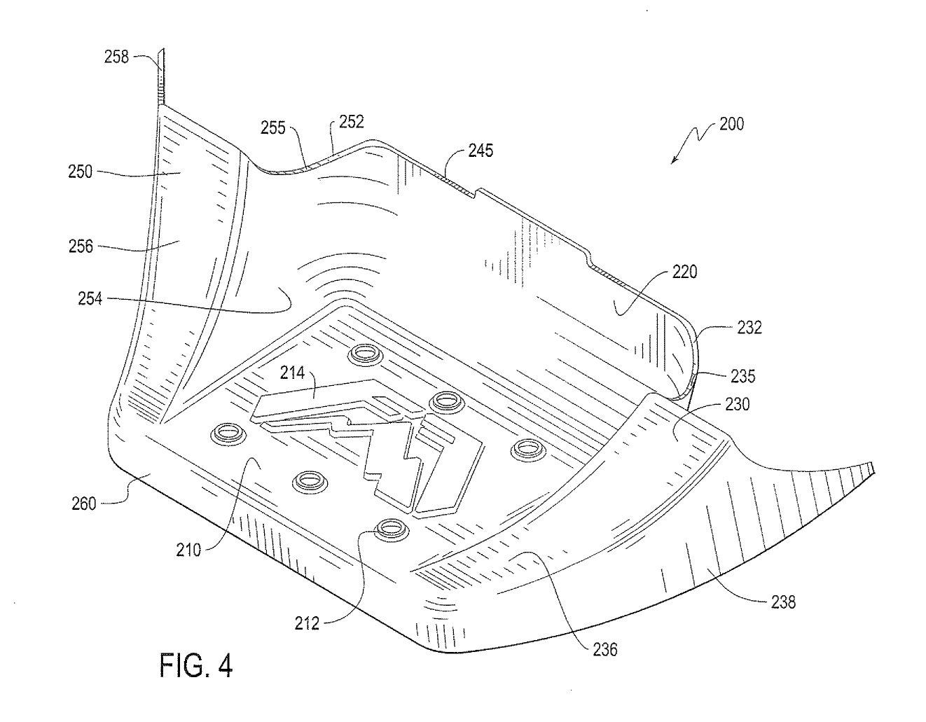

FIGS. 4-6 illustrate step 200 according to an embodiment. The step 200 may be stamped from a single sheet of material, such as by using a stamping press. The overall size of the step 200 can be customized. The step 200 includes a substantially flat tread 210 (bottom wall) that can be stepped upon. The tread 210 is preferably substantially horizontal, but may for example be somewhat sloped downward toward an open edge or perforation(s) for drainage. The tread 210 may include any number of protrusions and/or perforations 212 or a non-slip surface in order to prevent a user's foot from slipping on the tread 210 and/or for drainage. The tread 210 may include a logo 214 or other shapes stamped onto the tread 210 for advertising, for example. Of course, any other structure can be added to the step 200.

The step 200 of FIGS. 4-6 also includes a riser 220 that extends upwardly from the rear of the tread 210. The top of the riser 220 and the front (open end) of the tread 210 are preferably substantially perpendicular, with the bottom of the riser 220 curving or angled to meet the tread 210. When a user thus steps on the tread 210, the riser 220 prevents the front of the user's foot from slipping through the step assembly 100.

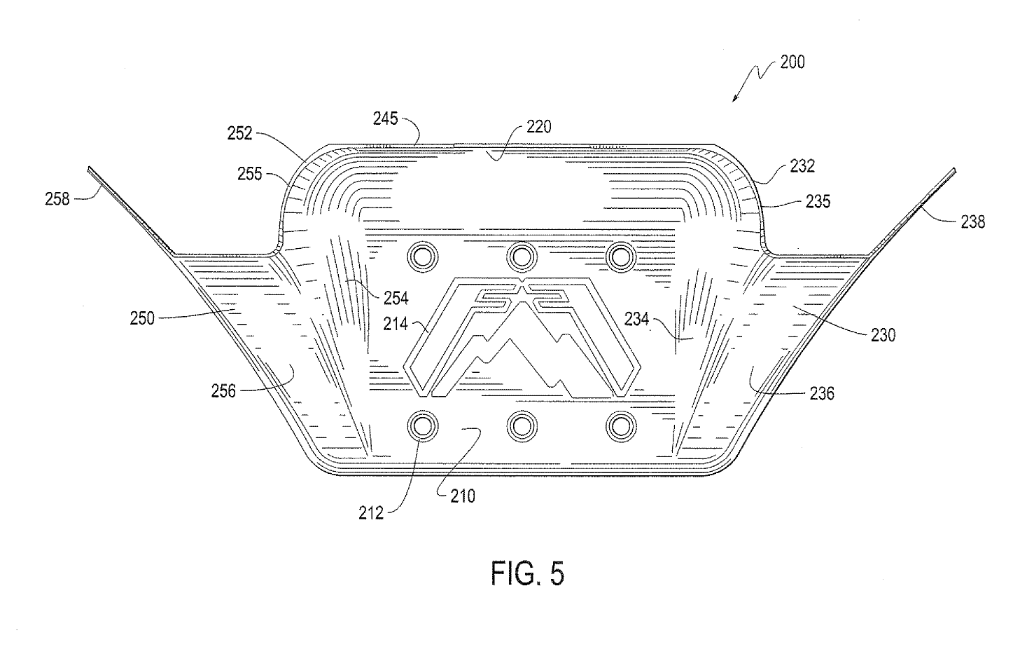

The step 200 preferably includes a pair of side portions 230, 250, respectively on the left and right sides (when viewing FIGS. 4 and 5) of the step 200. Each side portion 230, 250 may be substantially perpendicular to the tread 210, or may lean inward or outward. For example, the side portions shown in FIGS. 4 and 5 lean outward at the top of the step 200 as illustrated at 232, 252 such that the distance between the side portions 230, 250 is greater at the top of the step 200 than at the bottom. The larger opening at the top makes it easier for a user to place a foot into the step 200. It is also easier to store multiple steps because the bottom of a step 200 can be stacked on top of another step 200 via the larger opening.

Each side portion 230, 250 is preferably folded to form a generally inverted U-shaped configuration. The U-shaped configuration of the side portion 230 includes a side wall 234 that is adjacent to and is preferably integral with the tread 210 and the riser 220, a top part 236 that extends from the side wall 234. In embodiments, the top part 236 slopes outward and forms a concave curve to the front of the tread 210. An outer part 238 preferably extends from the top part 236 at an outward angle, as illustrated by FIG. 5. Similarly, the U-shaped configuration of the side portion 250 includes a side wall 254 that is adjacent to and is preferably integral with the tread 210 and the riser 220, a top part 256 that extends from the side wall 254 and may slope outward and form a concave curve to the front of the tread 210, and an outer part 258 that preferably extends from the top part 256 at an outward angle, as illustrated by FIG. 5.

In embodiments, the U-shaped configuration may be open as illustrated by FIG. 5 in order to provide a lighter, more cost effective step 200. The step 200 appears solid (i.e., not hollow) to the user because a user normally views only the front and sides of the step assembly 100. Of course, the U-shaped configuration may be partially solid or completely solid (e.g. trapezoidal) based on the process used to form the step 200.

The step 200 may also include a lip 260 that extends downwardly from the front of the tread 210 and from the front of the top parts 236, 256. Lip 260 is preferably integral with the outer parts 238, 258, which may also extend downwardly below the tread 210. The bottom of the lip 260 and the tread 210 are preferably substantially perpendicular, with the top of the lip 260 curving or angled to meet the tread 210 and the top parts 236, 256. The left and right sides of the lip 260 may also be curved or angled to meet the outer parts 238, 258.

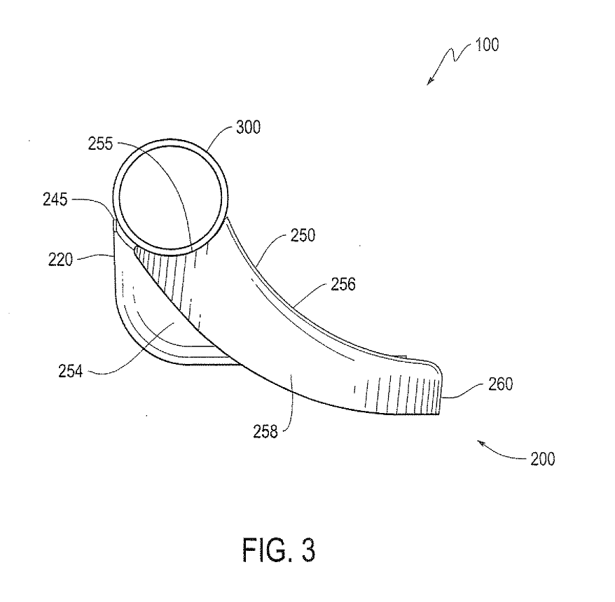

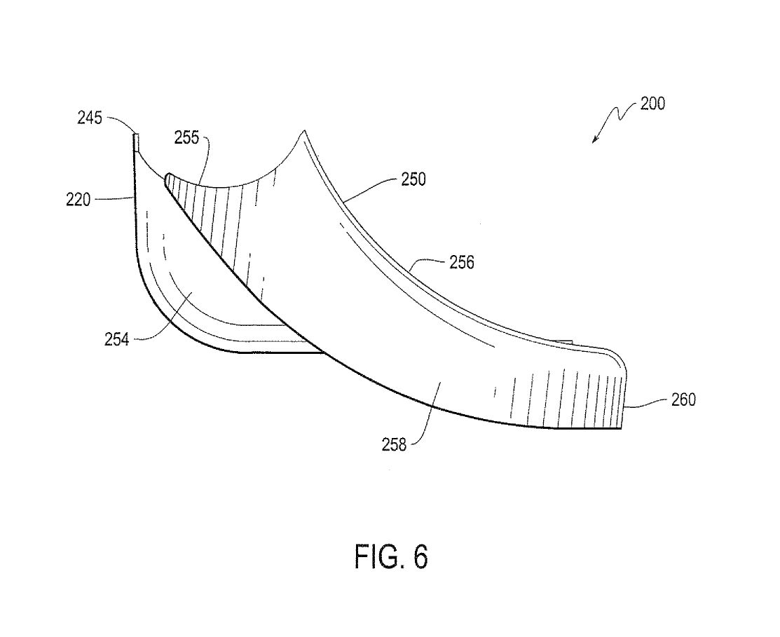

As illustrated by FIGS. 1-6, the top of the step 200 may preferably be formed such that the top of the step 200 corresponds to and mates with the shape of the bar 300. In embodiments as illustrated by FIGS. 3 and 6, the top of the side wall 254 and the top of the outer part 258 of the side portion 250 each have a shape that corresponds to and mates with the shape of the bar 300. The top of the riser 220 and the top part 256 of the side portion 250 are preferably configured such that the bar 300 can abut the top surface of the side wall 254 and the outer part 258 of the side portion 250 and so that the riser 220 and the top part 256 abut the bar 300. A similar configuration may be provided for the side portion 230.

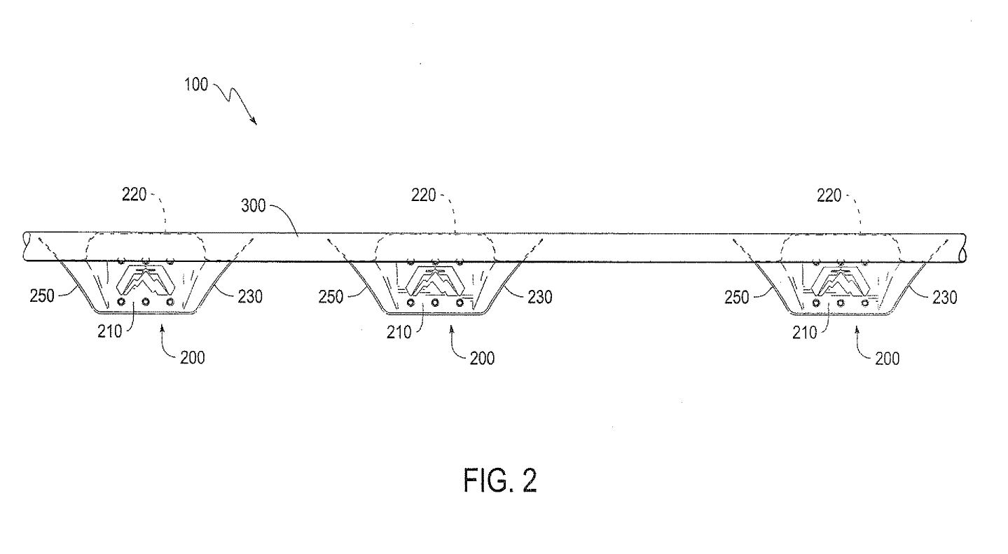

As a result, the step 200 can be rigidly attached by welding or the like to the bar 300 because the riser 220, each of the parts 234, 236 and 238 of the side portion 230, and each of the parts 254, 256 and 258 of the side portion 250 abut the bar 300 and some or all of them can be attached to the bar 300 by welding or the like, as illustrated by the top view of FIG. 2 and side view of FIG. 3.

As illustrated by FIGS. 1 and 2, the tread 210 and the side portions 230, 250 may each extend laterally beyond the bar 300. In particular, the side portions 230, 250 each extend laterally outward from the bar 300 along with the front part of the tread 210. A user can thus easily step on the tread 210.

Appropriate materials from which step 200 may be formed include metals such as steel or aluminum or thermoplastic, thermosetting or other moldable materials such as plastics and fiber-based material such as fiberglass. The step 200 can be formed by any appropriate method, such as stamping a single sheet of material, casting or injection molding.

In embodiments where the step assembly 100 is formed by stamping a single sheet of material in order to form the step 200, a single sheet of material is initially provided. The single sheet of material may be cut by any appropriate apparatus, such as a saw, shears, or laser, for example, or punched out using a tool, for example, in order to form a blank. The blank may then be stamped in order to start the drawing of the blank into a concave step shape. The blank may be trimmed before or after the initial forming in order to finetune surfaces that will correspond to and mate with the shape of the bar 300. The blank may then again be stamped in order to form the step 200. The blank may also be further stamped in order to form the protrusions and/or perforations 212 and/or the logo or other design 214. The step 200 is thus formed through the process of stamping and trimming. The manufacturing process may be simplified by forming the entire step 200 in one stamping process. Of course, the stamping process may include one stamping step or any number of stamping steps and/or perforating steps, and may include no trimming or any number of trimming steps in order to form the step 200.

In other embodiments, the step 200 may be molded or cast. For example, injection molding may be particularly suitable for some thermoplastic materials, particularly high-density plastics. Casting may be appropriate for materials such as aluminum. Additional coating steps could be performed for coloring, corrosion resistance, non-slip properties and the like. For example, powder coating may be desirable for color matching with a side bar or other vehicle components. Colored materials could also be used to form a step 200.

The top of the step 200 is placed in abutment with the bar 300. The step 200 is easily placed against and fits with the bar 300 when the top of the step 200 corresponds to the shape of the bar 300 as illustrated by FIG. 3. The step 200 is then attached to the bar 300 by welding, for example.

Of course, there are various other ways of attaching the step 200 to the bar 300. For example, the riser 200 and/or the top parts 236, 256 can be longer and curved to correspond to and mate with the shape of the bar 300 so that a bolt or the like can pass through the longer riser 200 and/or top parts 236, 256 and into the bar 300. This is particularly desirable for non-matching materials of the bar and step, for which welding may be difficult or impractical. For example, a step 200 that is formed by a metal such as aluminum or thermoplastic, thermosetting or other moldable materials such as plastics and fiber-based material such as fiberglass metals that cannot practically be welded to a steel bar may be attached to the bar 300 using bolts of the like.

Various advantages can be achieved with embodiments of the step assembly 100, step 200 and embodiments of the method of forming the step and/or step assembly. For example, the step 200 may easily be formed by using one stamping process. The riser 220 and/or side walls 234, 254 may be configured to prevent the user's foot from slipping through and/or off the step assembly 100. The step assembly 100 looks more advanced and is aesthetically improved when the top of the step 200 is curved to correspond to the shape of the tubular bar 300. The step 200 may be rigidly attached to the bar 300 by welding when the riser 220, and/or parts 234, 236 and/or 238 of the side portion 230, and/or parts 254, 256 and/or 258 of the side portion 250 abut the bar 300.

While specific exemplary embodiments have been described, it is evident that many alternatives, modifications, and variations will be apparent to those skilled in the art. Accordingly, exemplary embodiments as set forth herein are intended to be illustrative, not limiting, and changes may be made without departing from the spirit and scope of the disclosure.

1. A vehicle step assembly comprising;
a substantially horizontal cylindrical side bar; and
a step stamped from a single sheet of material attached to the side bar, wherein the step comprises:
a pair of side walls stamped from the single sheet of material.

2. The step assembly according to claim 1, wherein the step comprises:
a tread and a riser stamped from the single sheet of material.

3-4. (canceled)

5. The step assembly according to claim 2, wherein a top of the riser and a top of each of the side walls correspond to a shape of the side bar.

6. A method of forming a vehicle step assembly, comprising:
bringing a stamped step and a substantially horizontal cylindrical side bar into abutment; and
attaching the step to the side bar, wherein the step comprises a pair of side walls.

7. The method according to claim 6, wherein the step includes a tread and a riser stamped from a single sheet of material.

8. The method according to claim 6, wherein the step includes a tread and the pair of side walls stamped from a single sheet of material.

9. The method according to claim 6, wherein the step includes a tread, a riser and the pair of side walls stamped from a single sheet of material.

10. The method according to claim 9, wherein a top of the riser and a top of each of the side walls correspond to a shape of the side bar and the attaching is performed by welding.

11. A vehicle step assembly comprising:
a substantially horizontal cylindrical side bar; and
a step attached to the side bar, the step comprising a tread, a riser and a pair of side walls,
wherein a top of each side wall is shaped to mate with a shape of the side bar.

12. The step assembly according to claim 11, wherein the step includes a pair of side portions, each side portion includes a side wall of the pair of side walls, a top part that extends from the side wall and slopes outward toward a front of the tread, and an outer part that extends from the top part and extends at an outward angle.

13. The step assembly according to claim 12, wherein a rear portion of each top part is shaped to mate with the shape of the side bar.

14. The step assembly according to claim 12, wherein a top of the outer part is shaped to mate with the shape of the side bar.

15. The step assembly according to claim 12, wherein a top of each of the riser, the top part, and the outer part abut the side bar.

16. The step assembly according to claim 15, wherein the step is welded to the side bar at points of abutment of the riser, side walls, top part and outer part to the side bar.

17. The step assembly according to claim 11, wherein the step is formed from a single sheet of material.

18. A vehicle step comprising:
a tread,
a riser at a rear of the step that extends from the tread; and
a side portion with a side wall that is adjacent to and integral with the tread and the riser, a top part that extends from the side wall and slopes downward and outward toward a front of the tread, and an outer part that extends from the top part and extends at an outward angle toward a plane that contains the rear of the step.

19. The step according to claim 18, wherein the step is formed from a single sheet of material.

20. The step according to claim 18, wherein a top of the riser and a front of the tread are substantially perpendicular, with a bottom of the riser curving down to meet the tread.

21. The step according to claim 18, wherein the side portion includes a pair of side portions, each side portion leans outward at a top of the step such that a distance between the side portions is greater at the top of the step than at a bottom of the step.

22. The step according to claim 18, further comprising a lip that extends downward from a front of the tread and from a front of the top part.

23. A vehicle step assembly comprising;
a substantially horizontal side bar; and
a step stamped from a single sheet of material attached to the side bar, wherein the step comprises:
a pair of side walls stamped from the single sheet of material, wherein the side bar is attached to the side walls via an upper surface of the side walls.

24. A method of forming a vehicle step assembly, comprising:
bringing a stamped step and a substantially horizontal side bar into abutment; and
attaching the step to the side bar, wherein the step comprises a pair of side walls and the side bar is attached to the side walls via an upper surface of the side walls.

25. A vehicle step assembly comprising:
a substantially horizontal side bar; and
a step attached to the side bar, the step comprising a tread, a riser and a pair of side walls,
wherein a top of each side wall is shaped to mate with a shape of the side bar, and
wherein the side bar is attached to the side walls via an upper surface of the side walls.
